(19) United States
(12) Patent Application Publication
(10) Pub. No.: US 2001/0035122 A1
(43) Pub. Date: Nov. 1, 2001

(54) Tension overload indicator

(76) Inventor: Wayne Margetts, Ladysmith (CA)

Correspondence Address: ANTONY C. EDWARDS, BISHOP & COMPANY, SUITE 206, 347 LEON AVENUE, KELOWNA, BC, V1Y 8C7, CA

(21) Appl. No.: 09/824,814

(22) Filed: Apr. 4, 2001

Related U.S. Application Data
(60) Provisional application No. 60/194,409, filed on Apr. 4, 2000.

(51) Int. Cl. G01D 5/00

(52) U.S. Cl. 116/283; 116/281; 116/208

(57) ABSTRACT

A tension overload indicator includes a housing having a cavity extending along a longitudinal axis between oppositely disposed co-axial first and second apertures for journalling therethrough of a portion of a flexible load-bearing member. The housing has a third aperture having a bore axis orthogonal to the longitudinal axis. A rigid elongate member is slidably journalled in the third aperture between a recessed position wherein a visual warning signal on a distal end of the elongate member is recessed within the housing and a translated position wherein the warning signal is exposed from the housing. The elongate member extends into the cavity in the recessed position and is releasably locked in the recessed position by a shear member. The flexible load-bearing member is deflected out of co-axial alignment with the longitudinal axis by bending around the inner end of the elongate member. When a tension load in the flexible load-bearing member exceeds a safe load of the flexible load-bearing member corresponding to a shear strength of the elongate member, the flexible load-bearing member straightens in the cavity into alignment with the longitudinal axis so as to urge the elongate member into the translated position, thereby shearing the shear member.

### CROSS REFERENCE TO RELATED APPLICATION

This application claims priority from United States Provisional Patent Application No. 60/194,409 filed Apr. 4, 2000 entitled Tension Overload Indicator.

### FIELD OF THE INVENTION

This invention relates to the field of devices for indicating tension in ropes, cables, tie-downs, slings and other lifting devices in which a flexible member is tensioned so as to apply force to an object having mass.

### BACKGROUND OF THE INVENTION

In the prior art, applicant is aware of various efforts to apply tension indicating devices to cables or the like and in particular is aware of U.S. Pat. No. 3,838,235 which issued to St. Germain on Sep. 24, 1974 for a Cable Tension Responsive Switch, and U.S. Pat. No. 4,163,126 which issued to Van Mastrigt on Jul. 31, 1979 for a Tension Indicating Device. These devices are activated when the load on a cable reaches a predetermined value. Tensioning the cable deforms the cable so as to operate a plunger thereby closing an electrical contact cooperating with the plunger. Closing the electrical contact enables a warning indicator. In the St. Germain design, tensioning of a cable so as to straighten it, pulls a plunger against the return biasing force of a helical spring. In the Van Mastrigt design tensioning so as to straighten the cable lifts a rigid block clamped onto the cable against the resilient return biasing force of a bending bar.

Applicant is also aware of U.S. Pat. No. 4,027,130 which issued to Filip on May 31, 1977 for a Cable Activated Switch. Filip discloses tensioning a cable so as to straighten the cable against the return biasing force of a helical spring. As the cable straightens, an electrical contact is closed in the switch.

What is neither taught nor suggested in this prior art is the simplified system of the present invention in which a mechanical thrust pin is restrained by a shear pin against a biasing force of a deformed flexible member such as a cable. The advantages of such a system include that it may withstand loads which otherwise would require very large springs to resist the biasing force, that it can be left for long periods of time with the flexible member tensioned and not suffer from either a breakdown of the resistive force or a hysteresis effect such as found in resilient members such as springs, and that it is of a simplified design which minimizes the cost of manufacturing. In the St. Germain design, tensioning, so as to straighten, of a cable pulls a plunger against the return biasing force of a helical spring. In the Van Mastrigt design tensioning so as to straighten the cable lifts a rigid block clamped onto the cable against the resilient return biasing force of a bending bar.

The prior art designs employing helical springs or the like are generally for applications employing only thin flexible cables. They suffer from the disadvantages that only relatively light loadings may be supported on the cable before the helical spring is compressed for springs which are not overly large and, further, they are prone to losing their calibration after multiple, such as thousands, of cycles.

### SUMMARY OF THE INVENTION

The tension overload indicator of the present invention comprises a housing having oppositely disposed co-axial apertures for slidable journalling therethrough of a portion of a flexible load-bearing member. A thrust pin, shaft or elongate member is slidably journalled in a further aperture in the housing so as to be generally perpendicular to the flexible load-bearing member. A first end of the elongate member rests on, or is adjacent to, or rests on by means of a base, the flexible load-bearing member. When in a recessed position so that an opposite second end of the thrust pin is not exposed to the outside of the housing, the flexible load-bearing member is deflected out of co-axial alignment with and between the co-axial apertures so as to bend around the first end of the thrust pin extending into a cavity in the housing, the cavity containing the portion of the flexible load-bearing member. Slidable translation of the thrust pin in the further aperture, from the recessed position to an exposed position exposing a warning or other indicating color or device on the second end of the thrust pin, is resisted by a shear pin extending perpendicularly through the thrust pin. When a tension load in the flexible load-bearing member exceeds a safe load, the flexible load-bearing member straightens in the cavity and shears the shear pin thereby driving the thrust pin into its exposed position and exposing out of the housing the warning on the second end of the thrust pin.

Thus in summary, the tension overload indicator of the present invention includes a housing, an elongate member, and a shear member. The housing has a cavity extending along a longitudinal axis between oppositely disposed co-axial first and second apertures for journalling therethrough of a portion of a flexible load-bearing member. The housing has a third aperture communicating with the cavity. The third aperture has a bore axis orthogonal to the longitudinal axis.

The elongate member is rigid and slidably journalled in the third aperture so as to be generally perpendicular to the flexible load-bearing member. The elongate member slides along the bore axis between a recessed position wherein a visual warning signal on a distal end of the elongate member is recessed within the housing and a translated position wherein the warning signal is exposed from the housing. The elongate member extends into the cavity in the recessed position and is releasably locked in the recessed position by a shear member journalled through a first shear member hole in the elongate member and collinear second shear member hole in the housing.

The elongate member has an inner end cooperating with the load-bearing member so that when the elongate member is in the recessed position, the flexible load-bearing member is deflected out of co-axial alignment with the longitudinal axis between the co-axial first and second apertures. The load-bearing member bends around the inner end of the elongate member.

When a tension load in the flexible load-bearing member exceeds a safe load of the flexible load-bearing member corresponding to a shear strength of the elongate member, the flexible load-bearing member straightens in the cavity into alignment with the longitudinal axis so as to urge the elongate member into the translated position, thereby shearing the shear member.

The elongate member may be a shaft and it may have a color coding at the distal end. A rigid base may be provided, wherein the inner end of the elongate member rests on the base so as to sandwich the base between the inner end and the flexible load-bearing member. The shear member may be a shear pin. The housing may further include an adjustable collar adjustably threadably mounted into the housing. The third aperture may be formed through the collar so as to communicate with the cavity.

The housing may be formed of opposed facing cupped halves rigidly releasably fastened to one another. The first and second apertures may be sized so that the flexible load-bearing member is slidably journalled through the first and second apertures and the cavity.

### BRIEF DESCRIPTION OF THE DRAWINGS

FIG. 1 is, in cross-sectional view through the overload indicator housing, a flexible load-bearing member deflected by a recessed thrust pin.

FIG. 1a is an enlarged view of the thrust pin and flexible load-bearing member of FIG. 1 in its exposed position with the thrust pin translated by straightening of the flexible load-bearing member.

FIGS. 2a and 2b show the use of the tension overload indicator of the present invention on an overhead lifting device and on a sling lanyard respectively.

FIG. 3 illustrates the use of the tension overload indicator of the present invention on a sling lifting a weight.

### DETAILED DESCRIPTION OF EMBODIMENTS OF THE PRESENT INVENTION

The present invention does not suffer from the drawbacks of the prior art designs in that a cable overload condition is indicated without the requirement of an electrical circuit. Further, heavy loading in excess of 5000 pounds is provided for without the use of resiliently deflecting members to resist straightening of the flexible member under tension, to thereby resist loss of calibration due to cyclical hysteresis and to further resist shock loading during dynamic tensioning of the load on the cable.

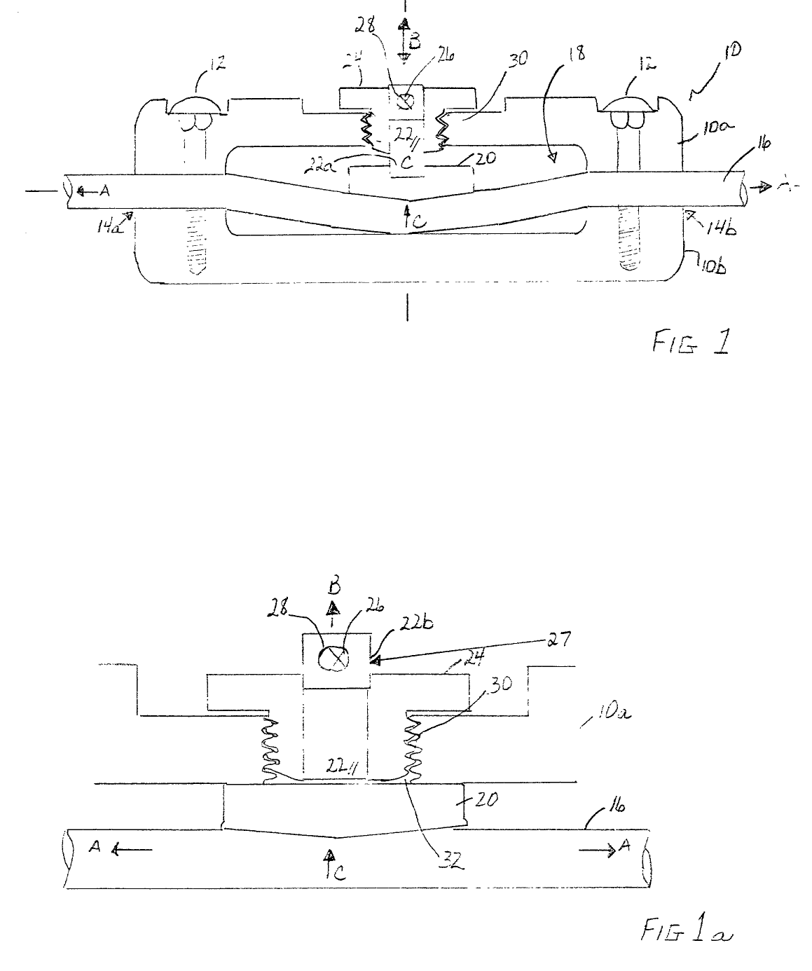

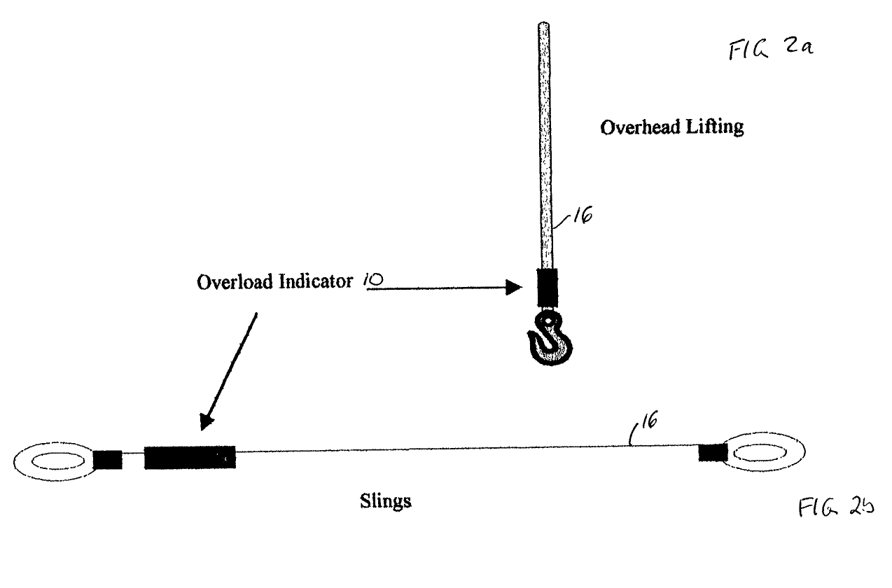

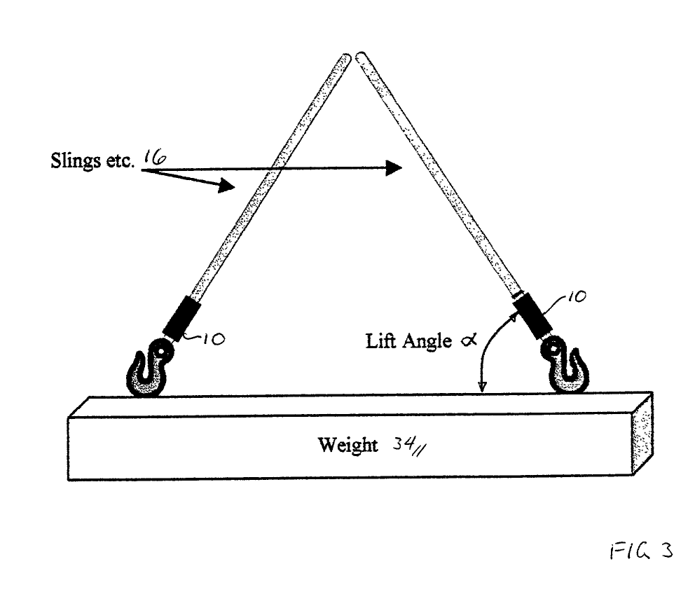

Thus, as seen in FIG. 1, a housing 10 having upper and lower halves 10a and 10b respectively may be mounted one to the other by means of bolts 12. Collinear apertures 14a and 14b are provided in either end of housing 10. The collinear apertures are sized for journalling of a flexible load-bearing member such as a wire rope or cable therethrough. Without intending to be limiting, flexible load-bearing member 16 may be any kind of cable, wire rope, tensionable tie-down, chain, synthetic sling webbing, line or rope or the like used in lifting devices, support cables for towers, bridge cables, tie-downs, slings and cranes such as illustrated by way of example in FIGS. 2a, 2b and 3.

Flexible load-bearing member 16 passes through cavity 18 within housing 10 between collinear apertures 14a and 14b. Flexible load-bearing member 16 is deflected within cavity 18 out of coaxial alignment with collinear apertures 14a and 14b when bypassed around saddle or base 20 mounted to the innermost end 22a of thrust pin 22 when in its recessed position as seen in FIG. 1.

Thrust pin 22 is slidably journalled co-axially in threaded collar 24 for slidable translation in direction B. In its recessed position, thrust pin 22 is slid through threaded collar 24 so as to extend inner end 22a and base 20 into engagement with flexible load-bearing member 16 so as to deflect flexible load-bearing member 16. Thrust pin 22 is maintained in its recessed position within threaded collar 24 by means of a shear pin 26. Shear pin 26 is indicated, without intending to be limiting, in FIGS. 1 and 2 by a rigid member having an X-shape in cross section. Shear pin 26 is journalled in corresponding bore holes 28 in thrust pin 22 and threaded collar 24.

The magnitude of the deflection of flexible load-bearing member 16 by thrust pin 22 and base 20 when thrust pin 22 is in its recessed position may be adjusted by threading threaded collar 24 into, or out of, its threaded mated engagement with corresponding threads 30 in threaded aperture 32 in upper half 10a of housing 10.

Once the tension (shown by direction arrows A) in flexible load-bearing member 16 increases as the load is taken up to lift a mass or weight 34, the tensile force in flexible load-bearing member 16 increases correspondingly. This increases the force in direction C, co-axial with the longitudinal axis of pin 22, and perpendicular to the tangent of flexible load-bearing member 16 as it passes through the longitudinal axis of thrust pin 22. It is the force in direction C which is resisted by shear pin 26. The shear strength of shear pin 26 is known and predetermined, that is, selected so that as the tensile force in flexible load-bearing member 16 reaches its maximum rated load, the tensile force vector in direction C matches the shear strength of shear pin 26. As the maximum load is exceeded, the force vector in direction C exceeds the shear strength of shear pin 26 causing shear pin 26 to shear off. This allows translation of thrust pin 22 in direction C from its recessed position into its exposed or translated position thereby exposing brightly colored warning button 27 on end 22b of thrust pin 22. Exposing warning button 27 alerts an operator to the over-tensioning.

Thus by way of example, if load-bearing member 16 is a one-half inch wire rope sling, the safe working load for the sling is 4000 pounds. In the event that an operator has correctly installed the sling so that lift angle α is approximately 60 degrees, and the operator tries to lift a weight 34 exceeding 4000 pounds, then the force vector in direction C will shear an approximately 2300 lb shear pin 26 on each wire thereby driving thrust pins 22 through threaded collars 24 into their extended position such as shown in FIG. 1a. In a preferred embodiment, the end 22b of thrust pin 22 thus exposed is a red colored warning button providing a visual warning indicator to the operator that the safe working load of flexible load-bearing member 16 has been exceeded.

In the example of FIG. 3, if the sling has been fitted incorrectly so that lift angle α is less than 60 degrees, in order to lift what might otherwise be a safe working load for weight 34, the tensile force in flexible load-bearing member 16 may exceed the safe tensile strength of the sling. This will cause the shearing of shear pin 26, thereby driving end 22b of thrust pin 22 outwardly of threaded collar 24 so as to expose the red colored warning button.

In the case of a one inch wire rope sling, a safe working load in the range of 36,000 pounds may be lifted. In this case dynamic forces such as shock loading may be resisted up to 44,000 pounds. This is accomplished by the use of an appropriate shear pin 26 and accomplishes a task which no resilient spring which is small enough to be feasible could handle. Further, the use of a shear pin as provided in the present invention allows for continual use of the device on a flexible load-bearing member wherein the flexible member may remain deflected within the housing for years before being called upon to indicate an overload condition.

Using a prior art device incorporating resilient members such as helical springs or bending bars, with the repeated load cycling over years, the resilient member will lose its calibration and eventually indicate an unsafe working load when in fact the working load did not exceed the safe working load of the flexible member. In contra-distinction, the shear pin as used in the present invention has a known and accurately predictable shear strength which remains substantially constant after repeated loading and repeated hot and cold seasonal cycles.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A tension overload indicator comprising:
a housing having a cavity extending along a longitudinal axis between oppositely disposed co-axial first and second apertures for journalling therethrough of a portion of a flexible load-bearing member, said housing having a third aperture having a bore axis orthogonal to said longitudinal axis,
a rigid elongate member slidably journalled in said third aperture so as to be generally perpendicular to said flexible load-bearing member for sliding along said bore axis between a recessed position wherein a visual warning signal on a distal end of said elongate member is recessed within said housing and a translated position wherein said warning signal is exposed from said housing, said elongate member extending into said cavity in said recessed position, said elongate member releasably locked in said recessed position by a shear member journalled through a first shear member hole in said elongate member and collinear second shear member hole in said housing,
said elongate member having an inner end cooperating with said load-bearing member so that when said elongate member is in said recessed position, said flexible load-bearing member is deflected out of co-axial alignment with said longitudinal axis between said co-axial first and second apertures said load-bearing member bending around said inner end,
wherein, when a tension load in said flexible load-bearing member exceeds a safe load of said flexible load-bearing member corresponding to a shear strength of said elongate member, said flexible load-bearing member straightens in said cavity into alignment with said longitudinal axis so as to urge said elongate member into said translated position shearing said shear member.

2. The indicator of claim 1 wherein said elongate member is a shaft having a color coding at said distal end.

3. The indicator of claim 1 further comprising a rigid base, and wherein said inner end of said elongate member rests on said base so as to sandwich said base between said inner end and said flexible load-bearing member.

4. The indicator of claim 3 wherein said elongate member is a shaft.

5. The indicator of claim 1 wherein said housing further comprises an adjustable collar adjustably threadably mounted into said housing, said third aperture formed through said collar so as to communicate with said cavity.

6. The indicator of claim 1 wherein said shear member is a shear pin.

7. The indicator of claim 1 wherein said housing is formed of opposed facing cupped halves rigidly releasably fastened to one another.

8. The indicator of claim 1 wherein said flexible load-bearing member is slidably journalled through said first and second apertures and said cavity.

9. The indicator of claim 5 wherein said elongate member is a shaft having a color coding at said distal end.

10. The indicator of claim 6 wherein said elongate member is a shaft having a color coding at said distal end.

11. The indicator of claim 7 wherein said elongate member is a shaft having a color coding at said distal end.

12. The indicator of claim 2 further comprising a rigid base, and wherein said inner end of said elongate member rests on said base so as to sandwich said base between said inner end and said flexible load-bearing member.

13. The indicator of claim 5 further comprising a rigid base, and wherein said inner end of said elongate member rests on said base so as to sandwich said base between said inner end and said flexible load-bearing member.

14. The indicator of claim 6 further comprising a rigid base, and wherein said inner end of said elongate member rests on said base so as to sandwich said base between said inner end and said flexible load-bearing member.

15. The indicator of claim 7 further comprising a rigid base, and wherein said inner end of said elongate member rests on said base so as to sandwich said base between said inner end and said flexible load-bearing member.

16. The indicator of claim 8 further comprising a rigid base, and wherein said inner end of said elongate member rests on said base so as to sandwich said base between said inner end and said flexible load-bearing member.

17. The indicator of claim 2 wherein said housing further comprises an adjustable collar adjustably threadably mounted into said housing, said third aperture formed through said collar so as to communicate with said cavity.

18. The indicator of claim 3 wherein said housing further comprises an adjustable collar adjustably threadably mounted into said housing, said third aperture formed through said collar so as to communicate with said cavity.

19. The indicator of claim 6 wherein said housing further comprises an adjustable collar adjustably threadably mounted into said housing, said third aperture formed through said collar so as to communicate with said cavity.

20. The indicator of claim 7 wherein said housing further comprises an adjustable collar adjustably threadably mounted into said housing, said third aperture formed through said collar so as to communicate with said cavity.
